(19) United States
(12) Patent Application Publication
(10) Pub. No.: US 2010/0055661 A1
(43) Pub. Date: Mar. 4, 2010

(54) PORTABLE RETRACTABLE DRY-ERASE BOARD AND METHOD THEREOF

(76) Inventor: WILLIAM HEGWOOD, Dallas, GA (US)

Correspondence Address: Woodcock Washburn LLP, Cira Centre, 12th Floor, 2929 Arch Street, Philadelphia, PA, 19104-2891, US

(21) Appl. No.: 12/199,090

(22) Filed: Aug. 27, 2008

(51) Int. Cl. B43L 1/00

(52) U.S. Cl. 434/420; 401/195; 434/421

(57) ABSTRACT

A portable, reusable writing surface, comprising, a housing having a slot, a shaft rotatably mounted to the housing; a rolling assembly in communication with the housing with a spring-loaded pawl gear carried by the shaft; a mounting eyelet on the housing; a mounting system for removably mounting the housing to a working surface; and a sheet of rewritable material attached at one end to the shaft and at the other end to a handle.

### TECHNICAL FIELD

The present invention relates generally to display boards and reusable writing surfaces, and more specifically to a portable dry-erase board and method, used in fixed and mobile applications and, thus facilitating use where conventional dry-erase boards are impractical.

### BACKGROUND

Instructors, teachers, group leaders and other presenters use display boards of various types to visually communicate information to others. Some display boards are mounting surfaces for charts, graphs, photos and pre-printed materials, while others offer a writing surface such as paper or erasable material. Dry-erase or “white” boards are a common type of rewritable display board that permits use of erasable markers on a reusable writing surface. Typically, such dry-erase boards are permanently attached to a wall or placed upon an easel, tripod or other support stand.

The popularity of dry-erase boards has encouraged their availability in limited portable configurations. Such limited portability has been accomplished using wheeled stands that may be pushed from place to place, such as between classrooms. Greater portability has required foldable or collapsible designs; however, these designs present disadvantages and limitations for users in mobile settings. Indeed, in applications involving law enforcement, fire fighting, public safety and military operations, the desirability of using a portable dry-erase board to present information to a group is offset by cumbersome designs that limit available writing surface area and require too much storage space during transport.

For example, most portable dry-erase boards require a separate stand, tripod or easel for support. Such additional equipment limits portability due to considerations of weight, convenience and ease-of-use, especially when traveling. Even when such additional equipment is not required, some portable dry-erase boards are designed for use on a table or other elevated surface and, therefore, are not self-contained, thereby reducing their utility in mobile applications.

Further, portable dry-erase boards that include a separate easel or integrated tripod/stand are more effective, i.e., more stable, when their supporting structures are heavy. The same characteristic that provides stability during use (i.e., more weight) detracts from the portability of the entire assembly.

Still further portable dry-erase boards are limited in the size of their available writing surface, particularly resulting from hinged designs that permit folding of the board for storage and transportation purposes.

Therefore, it is readily apparent that there is a need for a more mobile-friendly portable, retractable dry-erase board and method of use that functions to provide an adequately large writing surface, lightweight construction, stability during use, and small storage space requirements. There is a further need for a retractable design that enables rapid setup and storage without the mechanical limitations and user inconveniences of previous hinged or folding display board systems. There is still a further need for a design that avoids the added weight and lower portability of an easel, tripod or stand, even when such support structures are integrated into the dry-erase board.

### BRIEF SUMMARY

The present invention overcomes the above-mentioned disadvantages and meets the recognized need for such an apparatus by providing a portable, reusable writing surface, comprising, in its preferred form, a housing having a slot; a shaft rotatably mounted to the housing; a rolling assembly in communication with the housing with a spring-loaded pawl gear carried by the shaft; at least one mounting eyelet on the housing; at least one mounting device for removably mounting the housing to a working surface; and at least one sheet of rewritable material attached at one end to the shaft and at the other end to a handle.

More specifically, the present portable retractable dry-erase board in its preferred form provides a highly portable apparatus enclosed in a housing with a front cover and a back plate. A small recess, along the length of the lower edge of the front cover, forms a slot where the lower edge of the front cover joins with the back plate. There is at least one mounting eyelet disposed on the back plate. There is a shaft with a ratchet assembly, preferably a spring-loaded pawl gear, which is rotatably mounted to the housing and carried by the shaft. A sheet of rewritable material, preferably dry-erase material, is operatively connected to and wrapped around the shaft. The sheet of rewritable material may be withdrawn from the housing through the slot using a handle attached to the distal end of the sheet of rewritable material. The shaft and ratchet assembly, together with the sheet of rewritable material, work similarly to a conventional window shade, to automatically retract the sheet of rewritable material from its extended position back into the housing and rolled around the shaft. In its extended position, while in use, the sheet of rewritable material is secured to the working surface preferably using a magnetic strip along the handle, but may also be removably secured using various other attachment systems known to one of ordinary skill in the art.

The present portable retractable dry-erase board, in its preferred embodiment, works as follows. A user retrieves the device from storage, typically a vehicle trunk or other compartment. The user then sets up the device by removably mounting it onto a working surface such as a vehicle's trunk lid, hood, side panel, window or door. The device is preferably oriented to the vehicle by placing the back plate of the housing against a substantially flat working surface. The user employs removable mounting systems such as magnets, suction cups, hooks and loops (e.g., Velcro®), removable adhesive materials, straps, clips, cords, or fasteners between the mounting eyelet(s) on the housing and the working surface.

After setup is complete, the user would typically withdraw the sheet of rewritable material from the housing by grabbing the handle, which is operatively connected to the sheet of rewritable material at its distal end. The withdrawn sheet is secured to the working surface via one or more of the suitable position systems. The user may now use the device to write upon and to display information in the usual fashion.

To secure the device from its use, the user typically retracts the sheet of rewritable material back through the slot and into the housing, rolling the sheet back onto the shaft. In its preferred embodiment, by way of the ratchet assembly and spring-loaded pawl gear, the device would automatically retract the sheet of rewritable material and roll it onto the shaft after the user gives a quick pull on the handle at the distal end of the sheet. Thereafter, the user would put the device back into storage.

Thus, with its major aspects generally described above, the present portable retractable dry-erase board is highly portable. Accordingly, a feature of the present portable retractable dry-erase board is its ability to provide a lightweight, self-contained, portable rewritable writing surface for mobile applications.

Another feature of the present portable retractable dry-erase board is its ability to provide an alternative to existing portable dry-erase board designs by avoiding the need for a separate easel or an integrated tripod or stand.

Still another feature of the present portable retractable dry-erase board is its ability to remain stable during operation without the need for support structures such as an easel, tripod or stand, or the additional weight customarily used for stability.

Yet another feature of the present portable retractable dry-erase board is its small storage space requirements.

Yet still another feature of the present portable retractable dry-erase board is its extensible and retractable sheet(s) of rewritable material, which permits variable sizing of the writable surface area while providing as large a writable area as that of some conventional and non-mobile dry-erase boards.

These and other features and advantages of the present portable retractable dry-erase board will become more apparent to one skilled in the art from the following description and claims when read in light of the accompanying drawings.

### BRIEF DESCRIPTION OF THE DRAWINGS

The present portable retractable dry-erase board will be better understood by reading the Detailed Description with reference to the accompanying drawing figures, in which like reference numerals denote similar structure and refer to like elements throughout, and in which:

FIG. 1 is a perspective view of the preferred embodiment of the portable retractable dry-erase board;

FIG. 2 is a rear view of the preferred embodiment of the portable retractable dry-erase board;

FIG. 3 is an exploded perspective view of the preferred embodiment of the portable retractable dry-erase board;

FIG. 4 is a front view of the preferred embodiment of the portable retractable dry-erase board.

FIGS. 5A and 5B are rear perspective views of the preferred embodiment of the front cover from different angles.

FIG. 5C is a bottom view of the preferred embodiment of the front cover.

FIG. 6 is a perspective view of the preferred embodiment of the portable retractable dry-erase board in use, removably attached onto the side of a working surface.

### DETAILED DESCRIPTION OF THE PREFERRED AND SELECTED ALTERNATIVE EMBODIMENTS

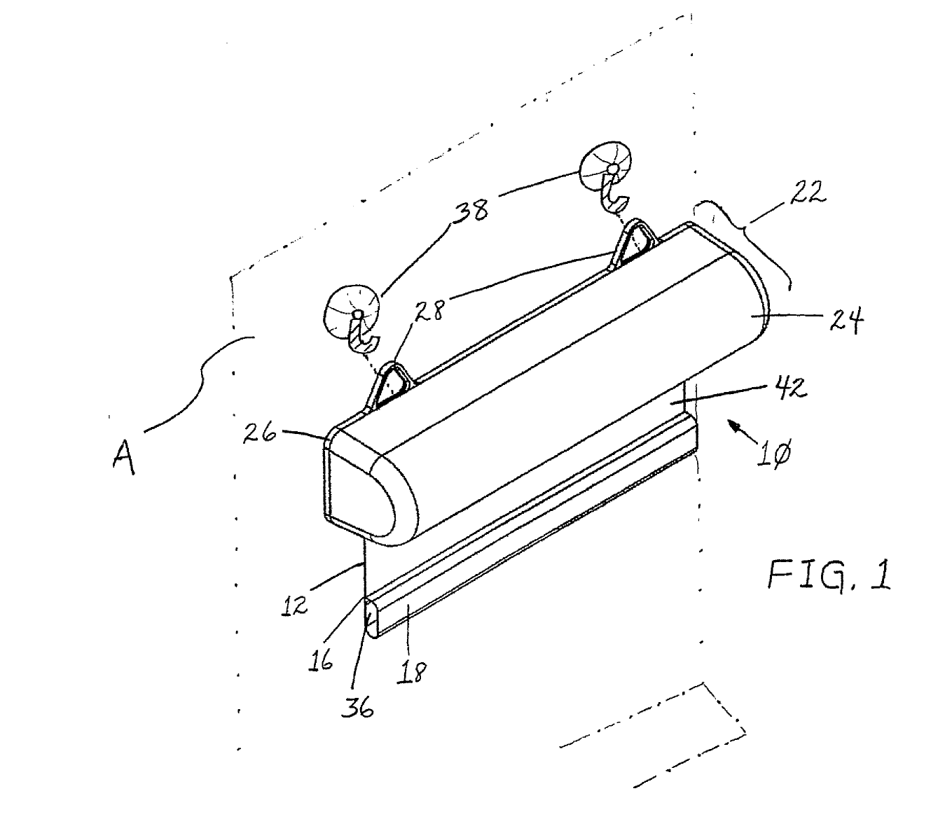

In describing the preferred and selected alternate embodiments of the present invention, as illustrated in FIGS. 1-6, specific terminology is employed for the sake of clarity. The portable retractable dry-erase board is not, however, intended to be limited to the specific terminology so selected, and it is to be understood that each specific element includes all technical equivalents that operate in a similar manner to accomplish similar functions.

Referring now to FIGS. 1-6, the present portable retractable dry-erase board in a preferred embodiment is a portable, retractable dry-erase board 10. Preferably, device 10 comprises a housing 22 having a slot 30, a front cover 24 and a back plate 26; at least one mounting eyelet 28 on back plate 26; a shaft 32 rotatably mounted to housing 22; rolling assembly 34 in communication with housing 22 with rolling assembly 34 carried by shaft 32; a mounting device 38 for removably mounting housing 22 to a working surface A; at least one sheet of rewritable material 12 attached at its proximal end 14 to shaft 32 and at its distal end 16 to at least one handle 18; and positioning device 36 for attaching handle 18 to the working surface A in a desired position.

Now referring to FIG. 1, by way of example, and not limitation, there is illustrated a perspective view of device 10 in accordance with a preferred embodiment of the present invention. Device 10 has a housing 22 with a front cover 24 and a back plate 26. Preferably, back plate 26 is substantially flat and has at least one mounting eyelet 28 positioned for balanced mounting of housing 22 onto the working surface A. A wide variety of mounting devices 38 are available to removably mount housing 22 to a working surface A. When used in conjunction with mounting eyelets 28, mounting device 38 is preferably a combination of suction cups and hooks; however, it is understood that mounting device 38 may be magnets, removably adhesive materials, tacks, nails, brads, screws, hooks, straps, hooks and loops, clips, ropes, twines, cords, fasteners and any other known means for mounting a housing to a working surface A, alone or in various combinations with one another. Stored inside housing 22 is at least one sheet of rewritable material 12, preferably a dry-erase material, with a proximal end 14 (not shown in this figure), a distal end 16, a front side 42 and a back side 43. It is contemplated herein that rewritable material 12 may include dry-erase, “white” board, writeable material, clear plastic or any other material or sheet of material capable of being written on and/or re-written on.

Rewritable material 12 may be transparent or opaque. Transparency of the rewritable material 12 permits visual aids such as maps, photographs, drawings and other pre-printed items to be removably secured onto back side 43 in a manner visible from front side 42. Thus, writing or drawing on front side 42 may be accomplished with reference to visual aids secured onto back side 43.

At distal end 16 is at least one handle 18, which preferably extends across a substantial portion of the width of rewritable material 12. Handle 18 permits the user to extend and retract rewritable material 12 out from and back into housing 22. Handle 18 has positioning device 36 for removably attaching and securing handle 18 to the working surface A in a desired position. Positioning device 36 is preferably at least one magnet carried by handle 18 for a metallic working surface A; however, it is understood that positioning device 36 may also be suction cups, removably adhesive materials, tacks, nails, brads, screws, hooks, straps, hooks and loops, clips, ropes, twines, cords, fasteners and any other system for attaching, securing, or positioning handle 18 to working surface A, alone or in various combinations with one another. Positioning device 36 preferably includes both magnetic and non-magnetic forms to permit handle 18 to be removably attached to metallic and non-metallic working surfaces A, respectively. In alternate embodiments, other positioning devices 36, such as, for example and not by way of limitation, suction cups, removably adhesive materials and hooks and loops (e.g., Velcro®), are available and suitable for non-metallic working surfaces, such as, for example, glass, plastic, Plexiglas® or wood.

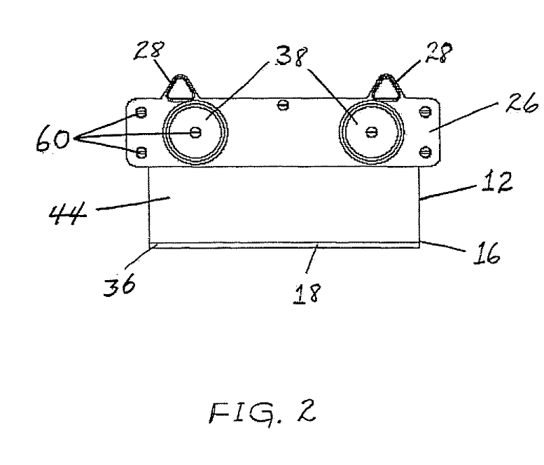

Referring now to the preferred embodiment shown in FIG. 2, device 10 is shown from the rear with mounting eyelets 28 on the top of back plate 26. Back side 44 is shown with rewritable material 12 partially extended from housing 22. Handle 18 is carried on distal end 16 of rewritable material 12, with positioning device 36 on handle 18. Back plate 26 is shown with mounting device 38 and a plurality of assembly screws 60.

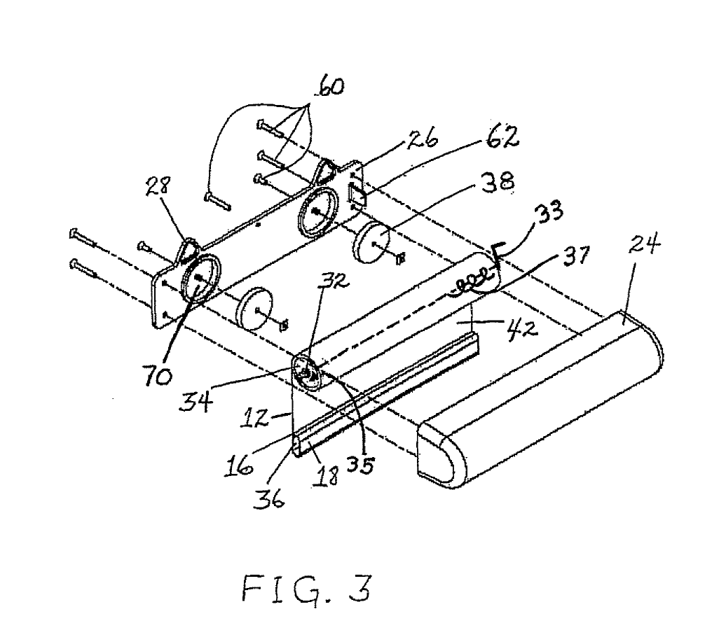

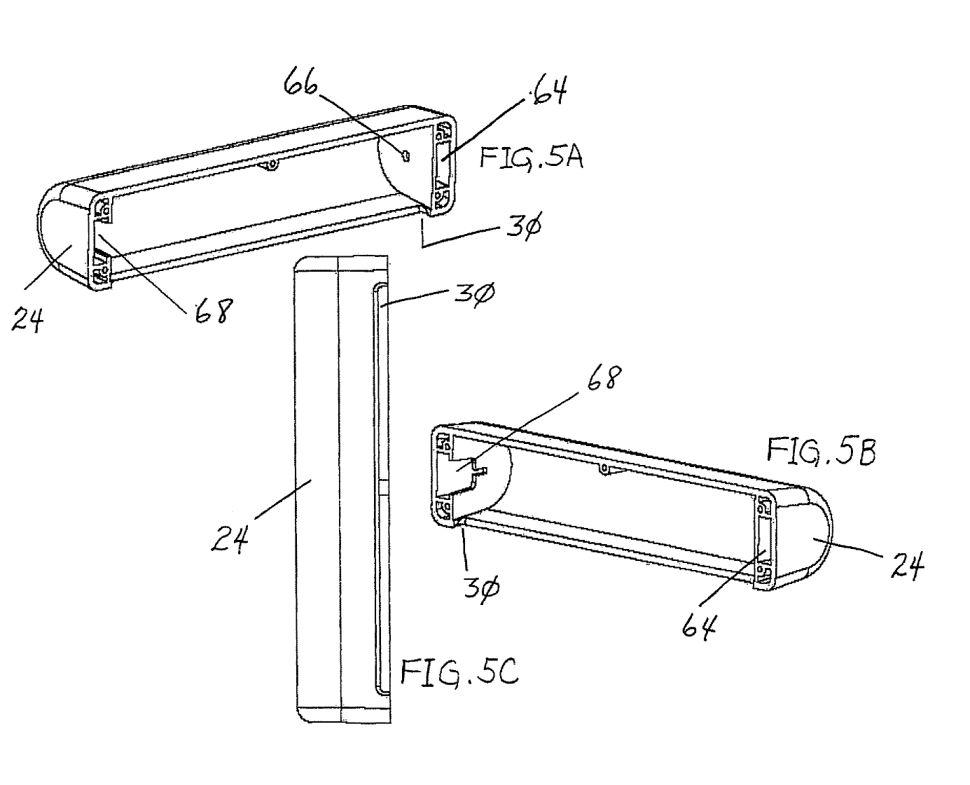

In FIG. 3, a preferred embodiment of device 10 is displayed in a detailed, exploded perspective view. Housing 22 is shown with front cover 24 and back plate 26. Disposed on back plate 26 is phalange 62 which, when inserted into a corresponding phalange receiver 64 (shown in FIGS. 5A and 5B), adds structural integrity and strength to housing 22 when fully assembled, and ensures the proper orientation during assembly of back plate 26 onto front cover 24. Also illustrated on back plate 26 are nooks 70 dimensioned to receive magnetic mounting device 38, wherein magnetic mounting device 38 is preferably secured in place using assembly screws 60 and assembly fasteners 72; however, it is understood that mounting device 38 may alternatively be secured using a pressure fitting, permanent or non-permanent adhesive, clips, gasket, or other means of holding mounting device 38 in place against or in operative communication with housing 22. Mounting device 38 is of sufficient strength (e.g., magnetic, adhesive, hooks and loops, etc.) to hold device 10 securely in place against the working surface A yet permit its removal without undue or excessive force, and is illustrated as round but is not limited to any particular shape or geometry.

Still referring to FIG. 3, showing device 10 in its preferred embodiment, front side 42 of rewritable material 12 is displayed with handle 18 disposed at distal end 16. Rewritable material 12 is rolled onto rolling assembly 34 carried by shaft 32. It is contemplated herein rolling assembly 34 may include spring-loaded pawl gear 35, spring assembly 37 or the like for retracting, extending or rolling rewritable material 12 onto rolling assembly 34 and into housing 22.

In an alternative embodiment, it is further contemplated herein that hand crank 33 may be affixed to rolling assembly 34 to provide a manual mechanism for driving shaft 32 and/or rolling assembly 34 to roll rewritable material 12 onto rolling assembly 34 and into housing 22. Hand crank 33 may include, but is not limited to, knobs, levers, handles, cranks, screws, wheels, drives, motorized mechanism and the like.

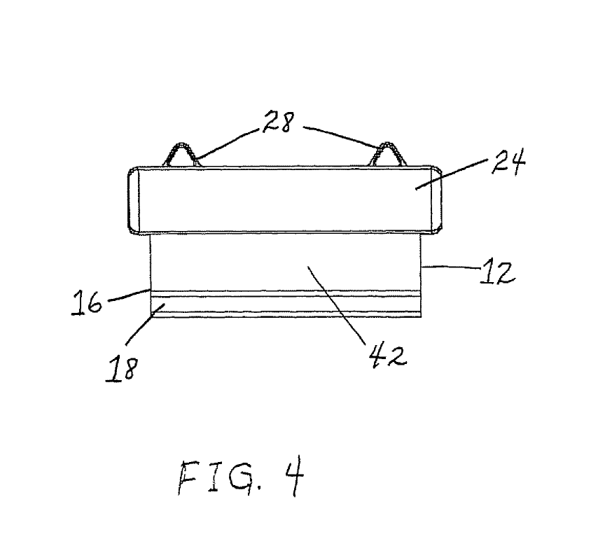

Now referring to FIG. 4, device 10 is displayed in a frontal view. Rewritable material 12 is partially extended from within housing 22, showing front side 42 of rewritable material 12 and handle 18 disposed on distal end 16. Also shown are mounting eyelets 28 extending from the top of back plate 26.

Front cover 24 is shown in FIGS. 5A and 5B, from two different angles in perspective views from the rear, revealing structural and functional elements of the preferred embodiment of the invention. Insertion flange 62 (shown in FIG. 3) fits into flange receiver 64, which is located on the back and at one end of, front cover 24. At the same end of front cover 24 as the flange receiver 64 is shaft receptacle 66, centrally positioned to receive one end of shaft 32. Shaft receptacle 66 is preferably dimensioned and shaped to receive one end, and to permit and support smooth rotation, of shaft 32. At the opposite end of front cover 24 from shaft receptacle 66, there is ratchet assembly slot 68, preferably disposed to operatively receive the other end of shaft 32 and rolling assembly 34. Ratchet assembly slot 68 and shaft receptacle 66, respectively, receive rolling assembly 34 and shaft 32, in a manner similar to the mounting and operating hardware of a conventional, spring-loaded window shade.

In the preferred embodiment of device 10, when fully assembled, front cover 24 and back plate 26 fit together, properly oriented by the insertion of phalange 62 into phalange receiver 64, secured using a plurality of assembly screws 60 (as shown in FIG. 3). It is understood that while such structural and function elements are preferably phalange 62 and phalange receiver 64, other alternate systems for providing strength and structural integrity to housing 22 are well-known to a person of ordinary skill in the relevant art.

Now referring to FIG. 5C, showing a bottom up view of the preferred embodiment of front cover 24, there is slot 30 formed where back plate 26 meets a small recess along the length of the lower edge of front cover 24, through which rewritable material 12 passes in and out of housing 22.

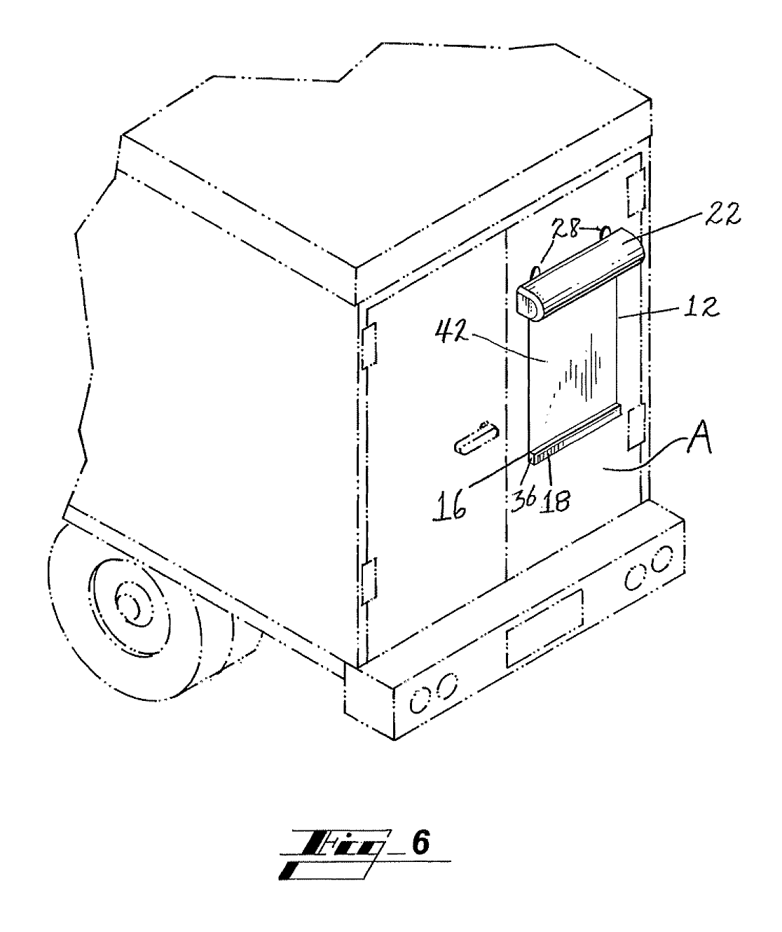

FIG. 6 displays the preferred embodiment of device 10 in use on a typical working surface A, i.e., a metallic door of a vehicle. Device 10 is shown removably mounted onto the metallic door with rewritable material 12 extended from housing 22 with front side 42 in clear view, facing away from the working surface A. Handle 18 at distal end 16 is removably attached to the metallic door using positioning device 36.

In one alternate embodiment of device 10, positioning device 36 is a detachable suction cup for removably coupling the back of handle 18 to a non-metallic working surface A on which magnetic attachment devices are not well suited. In another alternate embodiment of device 10, there is at least one pouch, pocket and other substantially transparent apparatus for placing pre-printed materials (e.g., photos, maps, drawings, etc.) in operational communication with rewritable material 12, or between back side 44 and front side 42, in a manner permitting visualization of such pre-printed materials by the user and others.

Having thus described the preferred and exemplary alternate embodiments of the present invention, it should be noted by those skilled in the art that the foregoing disclosures are exemplary only, and that various other alternatives, adaptations, and modifications may be made within the scope of the present version of the invention. Accordingly, the present version of the invention is not limited to the specific embodiments illustrated herein, but is limited only by the following claims.

What is claimed is:

1. A portable retractable writing surface comprising:
(a) a shaft, wherein said shaft is rotatable;
(b) a sheet of rewriteable material with a proximal end and a distal end, said proximal end operatively connected to said shaft;
(c) means for removably positioning said sheet of material to a working surface;
(d) means for extending said distal end of said sheet of material away from said shaft; and
(e) means for rolling said sheet of material onto said shaft, wherein said means for rolling is operatively connected to said shaft.

2. The portable retractable writing surface of claim 1, further comprising a ratchet assembly, wherein said ratchet assembly is operatively engaged to said shaft.

3. The portable retractable writing surface of claim 2, wherein said ratchet assembly is a spring-loaded pawl gear.

4. The portable retractable writing surface of claim 1, wherein said means for removably positioning said sheet of material to the working surface is selected from the group consisting of magnets, suction cups, removably adhesive materials, tacks, nails, brads, screws, hooks, straps, hooks and loops, clips, ropes, twines, cords, fasteners, and combinations thereof.

5. The portable retractable writing surface of claim 1, wherein said means for rolling said sheet of material onto said shaft is a hand crank carried by said shaft.

6. The portable retractable writing surface of claim 1, wherein said means for rolling said sheet of material onto said shaft is selected from the group consisting of knobs, levers, handles, screws, wheels, motors, machines and drives.

7. The portable retractable writing surface of claim 1, wherein said means for extending said distal end of said sheet of material away from said shaft is a handle.

8. The portable retractable writing surface of claim 1, wherein said means for extending said distal end of said sheet of material away from said shaft is a handle attached to said distal end of said at least one sheet of material.

9. The portable retractable writing surface of claim 1, wherein said means for rolling said sheet of material onto said shaft is a motorized mechanism.

10. The portable retractable writing surface of claim 1, wherein said means for extending said distal end of said sheet of material away from said shaft is a motorized mechanism operatively coupled to said shaft.

11. The portable retractable writing surface of claim 1, further comprising means for removably mounting said sheet of material and said shaft to the working surface, wherein said means for removably mounting is selected from the group consisting of magnets, suction cups, removably adhesive materials, tacks, nails, brads, screws, hooks, straps, hooks and loops, clips, ropes, twines, cords, fasteners, and combinations thereof.

12. The portable retractable writing surface of claim 11, wherein said means for removably mounting extends substantially across the width of said sheet of material.

13. A portable retractable writing surface comprising:
(a) a housing having a slot extending along a portion of the length of said housing;
(b) a shaft, wherein said shaft is rotatably mounted to said housing;
(c) a mounting device for removably securing said housing to a working surface;
(d) a sheet of rewritable material with a proximal end and a distal end, said proximal end being operatively connected to said shaft and said distal end passing through said slot; and
(e) a rolling assembly for rolling said sheet of material onto said shaft, wherein said rolling assembly is operatively connected to said shaft.

14. The portable retractable writing surface of claim 13, wherein said rolling assembly extends said distal end of said sheet of material away from said shaft.

15. The portable retractable writing surface of claim 13, wherein said rolling assembly is a spring-loaded pawl gear.

16. The portable retractable writing surface of claim 13, wherein said mounting device is selected from the group consisting of magnets, suction cups, removably adhesive materials, tacks, nails, brads, screws, hooks, straps, hooks and loops, clips, ropes, twines, cords, fasteners, and combinations thereof.

17. The portable retractable writing surface of claim 13, wherein said rolling assembly further comprises a hand crank.

18. The portable retractable writing surface of claim 17, wherein said hand crank is selected from the group consisting of knobs, levers, handles, screws, wheels, motors, machines and drives.

19. The portable retractable writing surface of claim 13, further comprises a handle attached to said distal end of said sheet of material and for extending said distal end of said sheet of material away from said shaft.

20. The portable retractable writing surface of claim 13, wherein said rolling assembly is a motorized mechanism operatively coupled to said shaft.

21. The portable retractable writing surface of claim 14, wherein said rolling assembly is a motorized mechanism operatively coupled to said shaft.

22. The portable retractable writing surface of claim 12, wherein said mounting device is selected from the group consisting of magnets, suction cups, removably adhesive materials, tacks, nails, brads, screws, hooks, straps, hooks and loops, clips, ropes, twines, cords and fasteners.

23. The portable retractable writing surface of claim 22, wherein said mounting device extends substantially across the width of said sheet of material.

24. The portable retractable writing surface of claim 13, wherein said mounting device further comprises a mounting eyelet.

25. A method of using a portable retractable writing surface, comprising the steps of:
(a) providing a housing having a slot extending along a portion of the length of said housing, a shaft, wherein said shaft is rotatably mounted to said housing, a mounting device for removably attaching said housing to a working surface, a sheet of rewritable material with a proximal end and a distal end, said proximal end being operatively connected to said shaft and said distal end passing through said slot, and a rolling assembly for rolling said sheet of material onto said shaft, wherein said rolling assembly is operatively connected to said shaft;
(b) securing said housing to the working surface;
(c) extending said distal end of said sheet of material away from said shaft; and
(d) displaying information on the writing surface.

26. The method of claim 25, further comprising the step of rolling said distal end of said sheet of material into said housing.

27. The method of claim 25, wherein the step of displaying information using the writing surface is selected from the group consisting of (i) writing on said sheet of material using a dry-erase marker, (ii) writing on said sheet of material using a permanent marker, (iii) superimposing a pre-printed object onto a portion of said sheet of material, (iv) projecting a visual image onto said sheet of material, (v) placing a magnetic object onto said a sheet of material, wherein said magnetic object is magnetically attracted to a metallic working surface through said sheet of material, and (vi) pushing a sheet-penetrating indicator through said sheet of material, wherein said sheet of material further comprises a substrate to receive said sheet-penetrating indicator.

28. A portable retractable writing surface comprising:
(a) a housing having a slot extending along a portion of the length of said housing, said housing having a front cover and a back plate;
(b) a shaft, wherein said shaft is rotatably mounted to said housing;
(c) a ratchet assembly carried by said shaft and in operative communication with said housing, wherein said ratchet assembly is a spring-loaded pawl gear;
(d) a mounting eyelet disposed on said back plate, wherein said mounting eyelet is in removable attachment with a working surface;
(e) a sheet of rewritable material with a proximal end and a distal end, said proximal end being operatively connected to said shaft and said distal end passing through said slot, wherein said sheet of material is a dry-erase material; and
(f) a handle attached to said distal end of said sheet of material and for extending said distal end of said sheet of material away from said shaft.
